(19) United States
(12) Patent Application Publication
(10) Pub. No.: US 2025/0069880 A1
(43) Pub. Date: Feb. 27, 2025

(54) APPARATUS FOR SEPARATING IONS

(71) Applicant: Thermo Fisher Scientific (Bremen) GmbH, Bremen (DE)

(72) Inventor: Hamish Stewart, Bremen (DE)

(73) Assignee: Thermo Fisher Scientific (Bremen) GmbH, Bremen (DE)

(21) Appl. No.: 18/810,129

(22) Filed: Aug. 20, 2024

(30) Foreign Application Priority Data
Aug. 21, 2023 (GB) 2312733.5

(51) Int. Cl. H01J 49/42

(52) U.S. Cl. CPC H01J 49/4215

(57) ABSTRACT

Ions are separated according to their mass-to-charge ratios. A separation region receives the ions, extending in a first direction and a second direction that is different to the first direction. An electrode arrangement confines the ions in the separation region. The electrode arrangement is configured to apply a time-varying potential in the separation region to cause the ions to move in the first direction and configured to apply a potential gradient in the separation region, the potential gradient opposing the time-10 varying potential, such that the ions are separated at different positions in the first direction according to the mass-to-charge ratios of the ions. A force is applied in the second direction to the ions to cause the ions to move in the second direction.

### CROSS REFERENCE TO RELATED APPLICATION

This application claims priority from application GB2312733.5, filed Aug. 21, 2023. The entire disclosure of application GB2312733.5 is incorporated herein by reference.

### FIELD

The present disclosure concerns an apparatus for separating ions according to mass-to-charge ratio.

### BACKGROUND

Devices for separating ions are used extensively in the field of mass spectrometry. Most tandem mass spectrometers employ a quadrupole mass filter (U.S. Pat. No. 2,939,952A) to isolate target ions prior to fragmentation and further downstream mass analysis. A drawback to this longstanding technology is that unselected ions strike the rods, leading to the loss of analyte ions (which may be scarce) whilst also contaminating and eventually damaging the electrodes. Depending on the isolation windows employed, the loss of theoretical sensitivity may exceed 99%.

One attempt to address these issues has been to accumulate and roughly separate ions in advance of the quadrupole, so that the mass-to-charge ratio (m/z) of ions delivered to the device approximately matches the range of the isolation window and ion losses are consequently reduced or minimized to the accuracy of the pre-separation. Some losses remain inevitable, unless the pre-separator is so good as to make the quadrupole redundant.

This method was proposed in GB2442638A, in which ions were first loaded into an ion trap. An RF pseudopotential barrier prevents release of ions of higher m/z, unless overcome by a direct current (DC) or travelling wave pushing the ions towards the exit, whereupon they would be released for quadrupole selection/fragmentation, etc. FIG. 3of GB2442638A shows trapping and sequential release over a pseudopotential. Preceding this, U.S. Pat. No. 6,794,641 B2 proposed a system in which ions were allowed to separate in an ion guide, in an m/z or mobility dependent manner under the influence of a traveling wave and emerge in a manner that could be linked to the mass range of an orthogonal ToF analyser, improving its duty cycle.

Many methods have been considered to achieve similar goals, similarly in U.S. Pat. No. 10,665,441 B2, and most successfully the parallel accumulation serial fragmentation method from a trapped ion mobility spectrometry (TIMS) device (Meier, F. et al. Parallel Accumulation-Serial Fragmentation (PASEF): Multiplying Sequencing Speed and Sensitivity by Synchronized Scans in a Trapped Ion Mobility Device. Journal of Proteome Research 2015, 12, 5378-5387, US20170122906A1 and U.S. Pat. No. 10,794,861 B2). Other variations include accumulation into multiple traps, either orthogonally across an RF pseudopotential (U.S. Pat. No. 10,199,208 B2) or via ion mobility (US20170076928A1).

Travelling waves are a known method of propelling ions through ion guides. Either a series of out-of-phase RF potentials (U.S. Pat. No. 7,375,344 B2), or switched DC pulses (Giles et al, Applications of a travelling wave-based radio-frequency-only stacked ring ion guide, Rapid Commun. Mass Spectrom. 2004; 18:2401-2414.) can be applied to successive axial segments of an ion guide. This creates a potential front that moves down the centre of the guide with time, dragging ions with it.

The interaction of a travelling wave and an opposing linear DC gradient has been previously described. U.S. Pat. No. 8,841,608 B2 describes the use of an opposing DC gradient to increase the residence time of ions in a T-wave driven mobility separator, improving resolution and also proposing bandpass filters to remove unwanted ions. FIG. 3 of U.S. Pat. No. 8,841,608 B2 shows a combination of a T-Wave and a retarding DC force.

Several ion guide technologies may be amenable to the application of travelling waves and/or DC gradients. Axial segmentation is typically required, and so stacked ring ion guides are most commonly used. PCB printed ion guides such as SLIM (Structures for Lossless Ion Mobility) allow a cost-effective method of applying segmentation and have been demonstrated with DC and RF travelling waves (Hamid et al, Characterization of Traveling Wave Ion Mobility Separations in Structures for Lossless Ion Manipulations, Anal. Chem. 2015, 87, 22, 11301-11308). RF carpets, which combine one RF surface with a DC counter-electrode, can be used with travelling waves (G. Bollen, “Ion surfing” with radiofrequency carpets, Int. J. Mass. Spectrom., 2011, 299, 131-138).

U.S. Pat. No. 6,914,241B2 and U.S. Pat. No. 6,838,662B2 describe methods of using an opposed travelling wave and DC gradient, including non-linear DC, to cause separation of ions within a guide. The ions reach equilibrium positions and may then be released in a time-dependent manner through a quadrupole, boosting efficiency. U.S. Pat. No. 6,914,241B2 indicates that ion mobility in a static gas field plays a role in the ions' equilibrium positions.

While the above-noted systems perform adequately in some respects, there remains a need for improved methods and apparatus for separating ions.

### SUMMARY

Against this background, the present disclosure provides an apparatus according to claim 1.

The present disclosure concerns apparatus for separating ions (e.g. ion guides) in which time-varying potentials (e.g. T-waves) push ions against a potential gradient (e.g. a DC gradient). Ions are caused to separate out and assume static positions along the ion guide according to their m/z and can then be released in m/z order to a downstream device (or downstream devices). The ion guides described herein can have two-or three-dimensional structures, where forces are applied to the ions orthogonally to the m/z separation direction to cause two-or three-dimensional ion motion. Such orthogonal forces can be provided by DC gradients, time-varying potentials (e.g. RF potentials or T-waves), or gas flows.

In generalised terms, therefore, the present disclosure provides an apparatus for separating ions according to the mass-to-charge ratios of the ions. The apparatus may be described as an ion guide that causes ions of different m/z values to pass through at different rates related to their m/z values.

Embodiments of the present disclosure include a separation region configured to receive the ions. This separation region may receive the ions from any upstream ion source (e.g. an external ion source), via any type of ion guide, conduit or channel. The separation region extends in a first direction and in a second direction (for example, in an orthogonal direction) that is different to the first direction.

Embodiments of the present disclosure include an electrode arrangement configured to confine (e.g. to trap for a substantial period of time) the ions in the separation region. The electrode arrangements of the present disclosure can comprise any number of individual electrodes or electrode segments. Each electrode of the electrode arrangements can be controlled by a controller coupled to all of the electrodes and configured to individually vary the voltages applied to the electrodes. The controller may be provided to one or a plurality of power sources to apply such voltages.

The electrode arrangements described herein are configured to apply a time-varying potential in the separation region to cause the ions to move in the first direction. The electrode arrangements are configured to apply a potential gradient in the separation region, the potential gradient opposing the time-varying potential, such that a combination of the potential gradient and the time-varying potential cause ions to separate at different positions in the first direction according to the mass-to-charge ratios of the ions. That is, different ions settle at different positions according to their m/z values. Ions are confined within the apparatus and separated under the combined influence of these applied potentials, which superimpose.

The apparatuses described herein are further configured to apply a force in the second direction to the ions to cause the ions to move in the second direction. For example, this may allow ions to move perpendicular to the direction in which they are separated, which can increase the volume available for the ions and hence reduce the impacts of space charge effects.

Methods are also provided. For example, there is provided a method for separating ions according to the mass-to-charge ratios of the ions, comprising: introducing the ions into a separation region extending in a first direction and a second direction that is different to the first direction; applying a potential in the separation region to confine the ions in the separation region; applying a time-varying potential in the separation region to cause the ions to move in the first direction; applying a potential gradient in the separation region, the potential gradient opposing the time-varying potential, to separate the ions at different positions in the first direction according to the mass-to-charge ratios of the ions; and applying a force in the second direction to the ions to cause the ions to move in the second direction.

While existing approaches such as U.S. Pat. No. 6,914,241 B2 and U.S. Pat. No. 6,838,662 B2 illustrate basic ion separation, some embodiments described herein provide two-dimensional (e.g. planar) structures with an additional DC or T-Wave (or other time-varying potential) forces or gas forces (e.g. due to gas jets or additional gas flows) orthogonal to the m/z separation direction.

Some embodiments provide multiple trapping regions at different positions in the first direction, while some embodiments provide switchable accumulation/transmission regions running in parallel to separation regions.

Embodiments of the disclosure provide various different benefits. An advantage of the devices described herein over more conventional axial ion traps, where only an exit region is defined, is that ions may be spread across a wide plane and space charge effects from dominant species may be localised and reduced. For any accumulation device set prior to isolation, space charge effects can cause severe problems. Thus, the disclosure can support very large devices, as the ions desired for release would always be close to the exit. The devices described herein may also be integrated into vacuum interface ion guides possessed by mass spectrometers that utilise atmospheric pressure ion sources, such as ESI (electrospray ionisation) ion sources.

A further advantage over existing devices is that highly controlled gas flows are not necessarily required (although these could be provided in some embodiments depending on requirements), greatly simplifying the engineering.

These and other advantages will become apparent from the following disclosure.

### LISTING OF FIGURES

The present disclosure will now be described by way of example, with reference to the accompanying figures, in which:

FIG. 1 shows potentials that can be used in embodiments of the disclosure;

FIG. 2 shows an apparatus according to an embodiment of the disclosure;

FIG. 3 shows a flowchart illustrating a method of operating embodiments of the disclosure;

FIG. 4 shows a mass spectrometry system incorporating embodiments of the disclosure;

FIGS. 5A and 5B show an embodiment of the disclosure and an applied travelling wave;

FIG. 6 shows the potential applied in an embodiment of the disclosure;

FIG. 7 shows simulated motion of ions in an embodiment of the disclosure;

FIG. 8 shows simulated motion of ions in an embodiment of the disclosure;

FIG. 9 shows simulated motion of ions in an embodiment of the disclosure;

FIG. 10 shows simulated motion of ions in an embodiment of the disclosure;

FIG. 11 shows potentials applied in an embodiment of the disclosure;

FIGS. 12A-12C show electrode arrangements for use in embodiments of the disclosure;

FIGS. 13A-13C show apparatus for separating ions according to embodiments of the disclosure;

FIG. 14 shows an apparatus for separating ions according to an embodiment of the disclosure;

FIG. 15 shows an apparatus for separating ions according to an embodiment of the disclosure;

FIG. 16 shows simulated motion of ions in an embodiment of the disclosure;

FIGS. 17A-17C show electrode arrangements for use in embodiments of the disclosure; and

FIG. 18 shows an apparatus incorporating embodiments of the disclosure.

### DETAILED DESCRIPTION

Some embodiments of the present disclosure address problems associated with ion loss of unselected ions, for example during quadrupole isolation. Whilst the related problem of rod contamination may be substantially addressed by more tolerant pre-filtering quadrupole segments (USRE45553E), the sensitivity loss can be avoided or at least reduced by using some level of pre-accumulation and separation.

A known process that achieves this is pre-accumulation in a TIMS device, which can enhance the sensitivity of TIMS-ToF instruments by an order of magnitude. Disadvantages of such devices are limited space charge capacity and the need to supply a laminar flow of opposing gas force. Separation by drift rather than properly matching m/z to the quadrupole presents some limitation in terms of achievable performance, and an effect that differing charge states are filtered. This latter part is beneficial for peptide identification applications as singly charged ions, unlikely to arise from digested peptides, can be discriminated against.

Any method that does not spread ions out across a wide space will suffer heavily from space charge effects, including TIMS but also all single trapping modes (including the apparatus described in GB2442638A). Methods that allow streamed separation and arrayed traps, such as in U.S. Pat. No. 10,199,208 B2 and US20170076928A1, will be much more resistant to space charge effects, but suffer from considerable complexity. U.S. Pat. No. 6,914,241 B2 and U.S. Pat. No. 6,838,662 B2 provide examples of ions spread over a long channel. Some embodiments described herein propose ion trapping methods that separate ions out within a relatively large trapping volume (e.g. a 2D planar region or a large 3D volume), so that space charge effects are reduced.

Methods that separate according to ion drift times tend to require accumulation in a small space, and thus suffer from space charge limitations, or large separation devices to achieve workable results. Generally, a low footprint device is desirable. Large ion guides may require PCB based construction (such as SLIM), which introduce risks from charging of exposed insulating material, or by use of more exotic structures like helices.

Widening a quadrupole (or other mass filter) isolation window can enhance sensitivity, and for very low ion load applications the m/z window may be beneficially increased even to extreme widths (such as 100), compared to a more regular single m/z target width of 1 or 2. However, the great complexity of multi-precursor fragment spectra can pose problems for deconvolution and identification software, although this area is advancing rapidly (Frejno et al, CHIMERYS: An AI-Driven Leap Forward in Peptide Identification, Proceedings of the 69th ASMS Conference on Mass Spectrometry and Allied Topic, Philadelphia PA, 2021 and Demichev et al, (2020). DIA-NN: neural networks and interference correction enable deep proteome coverage in high throughput. Nature methods, 17(1), 41-44.).

Some methods of non-destructive selection may remove the need for a quadrupole. For example, high resolution ion mobility using ion guides amenable to very long drift paths (U.S. Pat. No. 8,835,839 B1, GB2574796A), for example, may produce sufficient separation quality and slow ion release that their output may be directly coupled to a fragmentation device and primary analyser. Quadrupole RF ion trap isolation with axial collection of ions may be of sufficient resolution but in principle will suffer too greatly from space charge and ion capacity for fine isolation.

Hence, there remains a need for improvements to the way in which ions are separated and processed. For example, it is desirable to alleviate the effects of space charge while providing good separation of ions.

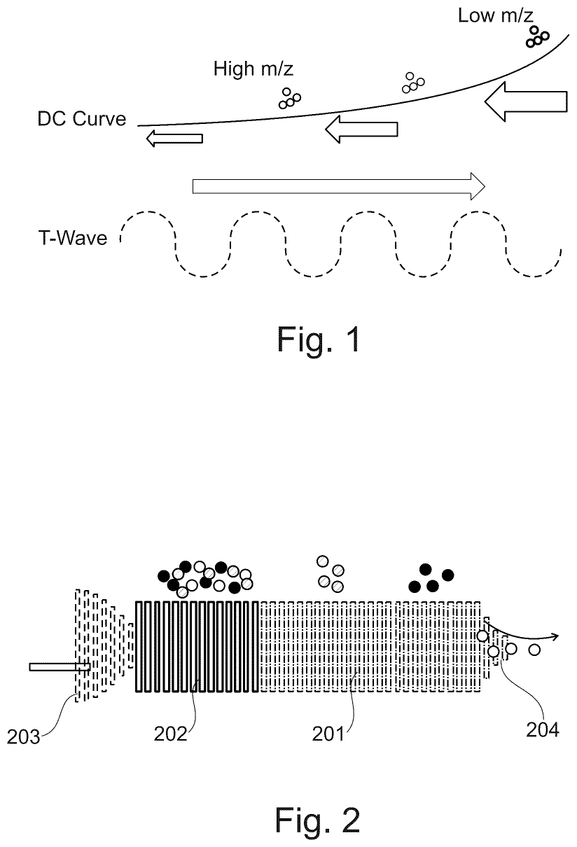

FIG. 1 shows the potentials used in certain embodiments of the present disclosure. The potentials in FIG. 1 can be used in an apparatus for separating ions according to the mass-to-charge ratios of the ions. In general terms, such an apparatus may comprise a separation region configured to receive the ions (e.g. from an upstream ion source), the separation region extending in a first direction and a second direction that is different to the first direction.

The apparatus used to implement the potentials in FIG. 1 may comprise an electrode arrangement configured to confine (e.g. trap, for at least some time, under the influence of the various potentials applied by the electrode arrangement) the ions in the separation region. The electrode arrangement is configured to apply a confining potential, thereby confining the ions within the separation region. The electrode arrangement is configured to apply a time-varying potential in the separation region to cause the ions to move in the first direction. The electrode arrangement is configured to apply a potential gradient in the separation region, the potential gradient opposing the time-varying potential, to separate the ions at different positions in the first direction according to the mass-to-charge ratios of the ions (i.e. different ions may settle at different places due to the differing impacts of the time-varying potential and the potential gradient on ions of different m/z). The various potentials (e.g. time-varying potentials, potential gradients, and confining potentials) applied in the separation region may superimpose; for instance, a time-varying potential (e.g. T-wave) and potential gradient (e.g. DC gradient) may be superimposed onto a confining potential (e.g. a confining RF potential).

The electrodes of the electrode arrangement may be controlled by a controller that is coupled to all electrodes, and all electrodes may be connected to a power source to apply potentials. Some or all of the electrodes may be individually and independently controllable.

FIG. 1 shows a non-linear DC gradient (an opposing potential gradient) and a travelling wave (a time-varying potential) inducing separation of ions over a length. FIG. 1 shows the travelling wave at a single instance in time; in practice the travelling wave is caused to travel continuously in the first direction. The opposing DC and pseudopotential forces cause ions of different m/z to settle at different positions.

To achieve the m/z dependent separation of FIG. 1, ions may be separated by opposing a potential gradient (e.g. a static field) with a pseudopotential force generated by a dynamic (time-varying) potential. In some embodiments of the present disclosure, an axial pseudopotential generated by a travelling wave (T-Wave) opposes a rising DC gradient. Such a T-Wave could be a multi-phase (e.g. 4-phase, or higher) travelling wave. The pseudopotential force pushes ions until they reach a region where the DC force is equal to or greater than the pseudopotential force, at which point the ions become trapped (or if the DC gradient is insufficient then the ions are pushed out of the device). As pseudopotential force is dependent on m/z, the trapping position of the ions also depends on their m/z. Hence, ions may be trapped at various different positions in the separation (first) direction.

Separated ions may be released from the device in an m/z-dependent fashion by scanning/stepping the applied DC potential or the travelling wave amplitude/frequency (or duty cycle/pulse velocity for digital waveforms). Alternatively, many other ways of extracting ions from the guide may be applied: the DC gradient and T-Wave may be removed and ions released over time based on their spatial separation/drift time, or a very slow travelling wave applied to drive out ions in slow bunches, etc. Accumulated ions may then be released, for example to a quadrupole (or other mass filter) matching their m/z, and the losses at the quadrupole may thus be mitigated.

Because the application of a travelling wave potential typically requires axial segmentation of electrodes, the arrangement in FIG. 1 is suitable for a stacked ring ion guide and related structures. FIG. 2 shows an example of an ion guide structure, which is an apparatus for separating ions in which the approach of FIG. 1 can be implemented. The apparatus comprises a separator region 201, a pre-accumulation region 202, a funnel/initial capture region 203, and an ion outlet 204.

In this specific example, the separation device has a stacked ring structure, also including optional sections for ion capture from an inlet capillary and a pre-accumulation region 202 to maximise duty cycle. In addition to a separation region 201, in which a T-Wave and DC gradient are applied, the apparatus is shown as comprising a similar pre-accumulation region 202 for pre-accumulation of ions whilst the separator 201 is in operation. An ion funnel 203 receives ions from an inlet capillary, and a small, funnelled region compresses the extracted ions as the ions pass out of the device to a higher vacuum (lower pressure) region. The funnelled 203 and pre-accumulation regions 202 may have their own DC offsets and gradients imposed, and a controllable (i.e. variable) DC barrier may be provided between the accumulator 202 and the separator 201. Potentials (e.g. from auxiliary electrodes, which are not shown) can be applied within the guide to cause the ions to move laterally (i.e. perpendicular to the axis of the ion guide), to permit spreading of high amounts of charge over a wider area to reduce space charge effects. After the ions have passed through the separation region 201, they exit the apparatus through the ion outlet 204, for example to a higher vacuum (lower pressure) ion guide. Hence, in generalised terms, the separation regions and/or accumulation regions described herein may be a vacuum region(s). The separation region and/or accumulation regions may be at a lower pressure than an upstream region (i.e. a region that is upstream of the separation region and/or accumulation region) of the apparatus and/or may be at a higher pressure than a downstream region (i.e. a region that is downstream of the separation region and/or accumulation region) of the apparatus. Various gas-tight housings and pumping can be provided to ensure a vacuum is formed.

The properties of the travelling wave are preferably set such that ions pass over the waves, such that the ions feel the influence of a pseudopotential force rather than being completely entrained in the waves. For example, the frequency and/or voltage amplitude of the travelling wave may be varied to achieve this. In principle, a high enough travelling wave potential will just carry ions away and there will be no separation, unless an opposing DC is set high enough to balance this effect. Therefore, the opposing potential and the time-varying potential may be fine-tuned to optimise separation performance.

### Practical Implementations

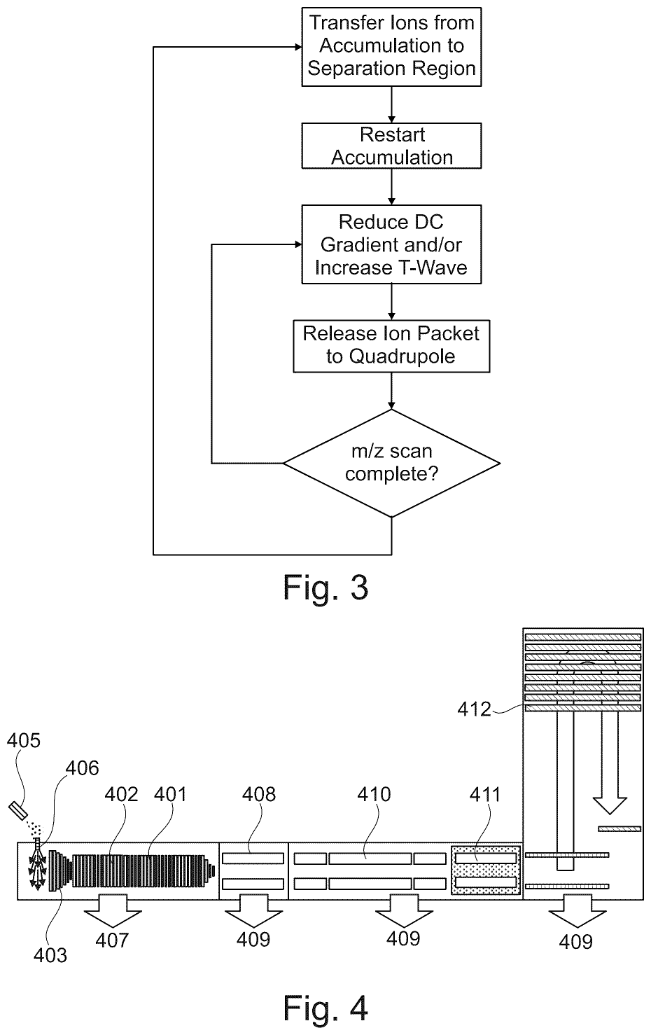

FIG. 3 shows a flowchart for the operation of an accumulator/separator combined device of the type described with reference to FIG. 2. First, an accumulated packet of mixed m/z ions is transferred from an accumulation region to a separation region, which may be achieved via application of either DC gradient/offset across the accumulator or a travelling wave to push ions along. Once emptied of ions, the accumulator then closes to the separator and begins accumulating further ions as they enter. In parallel to this, the process of separation begins in the separator. The DC gradient (which is preferably curved) amplitude is reduced (or alternatively an increase in travelling wave amplitude is provided, or both) to the level required for the first, lowest, target m/z range to exit. After a short delay (typically on the order of 0.25-5 ms), the target ions exit the system and travel to the downstream quadrupole (or other mass filter) for finer isolation. The DC gradient may then be further reduced to the next target m/z in the sequence and so on until the m/z range is exhausted, whereupon the accumulation region may be once again emptied, and the cycle repeated.

Thus, in each cycle of the separation device, multiple distinct mass ranges are sequentially released from the separation device.

FIG. 4 shows a suitable instrument layout incorporating embodiments of the present disclosure. The instrument comprises a separation region 401, a pre-accumulation region 402, an ion funnel 403, an ion source 405 (which in this example is an electrospray ion source), an ion inlet 406 (which is shown as an inlet capillary), a fore-pump 407, an intermediate ion guide 408, turbo-pumps 409, a resolving quadrupole 410, a collision cell 411, and a mass analyser 412 (which is shown as an orthogonal time-of-flight mass analyser).

In use, electrosprayed ions are admitted to the vacuum system via the capillary 406 and collected by the ion funnel 403, which delivers the ions to the accumulation and separation devices 402 and 401. Ions evicted from the ˜1 mbar pressurised separator 401 are passed to the quadrupole 410 (˜1×10⁴ mbar) for fine isolation via at least one intermediate ion guide 408 (˜5×10⁻² mbar) to allow adequate differential pumping. Selected ions are then fragmented in the collision cell 411 and fragments measured by a suitable mass analyser 412, which can be a time-of-flight analyser as shown, or any other suitable mass analyser, such as one or more of a quadrupole, ion trap or orbital trapping mass analysers.

The arrangement in FIG. 4 can be optimised in certain ways. Careful alignment of the quadrupole 410 and extracted mass range can be advantageous. If it is desired to align a quadrupole isolation window to the ions being released by the separator, the resolution of both may be considered. For example, if the separator resolution allows an m/z window of only 100, and the trapped range is 100-1000, then releasing m/z 100 will also substantially release up over m/z 150, at which point there may be little benefit in having the quadrupole inject m/z 100 and then 110 (as the m/z 110 ions will already be gone). Therefore, it may be advantageous to stagger (i.e., space) the quadrupole isolation ranges to match what has not already been released from the separator, and then return to fill in the gaps with the next separator cycle. That is, when the separator has a lower resolution than the quadrupole, the separator will release a wider range of ions than the quadrupole transmits, which are then lost on the rods, and so it is futile in this case to try to isolate these ions without first refilling the separator.

The number of mass ranges per cycle depends on the separator resolution, as well as the balance between ion current and space charge. For example, if the mass resolving power of the separator 401 is ˜10% and the trapped range 10×, then a maximum 10 separate mass ranges may be extracted in a cycle. The quadrupole meanwhile may be operated in a DIA (data independent acquisition) method scanning through much smaller mass windows, which could therefore be interleaved with the larger separator extractions. For example, a range of 100-1000, with stepped separator extractions of 100-200, 200-300 . . . 900-1000, is considered. A quadrupole running through 10 m/z isolation windows cannot run in the regular sequence 100-110, 110-120 etc., but may instead take a single shot from each extracted range per separator cycle: 100-110, 200-210 . . . 900-910 then 110-120, 210-220 . . . 910-920 and so on. If each extraction cycle may be completed in ˜100 ms, similar to a TIMS device, then the full DIA cycle would take around a second.

For DDA (data dependent acquisition), a precursor list may be generated from unfragmented MS1 data, which may either be a true full mass scan or some combination of this with separator extracted mass ranges for low abundant regions of the spectrum, for a Boxcar/Orbitrap™ HDR-like spectrum, only vastly more efficiently gathered. Target species from the precursor list may be removed in an optimized order; one per extracted mass range per separator cycle. These ranges may be set dynamically, to the limit of the separator resolving power, based on ion current/number of targets, etc.

Not shown in the flow chart of FIG. 3 is the understanding that the entire accumulator/separator device 401/402 of FIG. 4 may be opened and the full range of ions allowed to pass as in a regular mass spectrometer. This may be useful for occasionally acquiring full range spectra, or for measuring very intense peaks that might exceed the instrument's dynamic range (such a segment could be easily specified in a data dependent precursor list, or certain isolation windows otherwise flagged based on automatic gain control AGC data (i.e. from MS1 scans or pre-scans) and taken out of the accumulator DIA sequence). The great pulse of ions from the accumulator that initially emerges upon setting the device to streaming mode may either be ignored or otherwise used in a super-high-load full-MS scan.

In general terms, embodiments of the present disclosure may be incorporated in a mass spectrometry system comprising: any of the apparatus for separating ions described herein; and a mass filter (e.g., a quadrupole) downstream of the apparatus, the mass filter configured to receive the ions from the apparatus. The isolation window of the mass filter may correspond to the mass-to-charge ratio of the ions extracted from the separation region. A mass analyser may be provided and configured to receive the ions from the mass filter or ions derived from those ions (e.g. fragment ions) and perform mass analysis on the received ions.

### Simulations of Embodiments of the Disclosure

The efficacy of embodiments of the present disclosure can be demonstrated using simulations. Simulations described herein are performed with the MASIM3D software suite, designed to probe and optimise apparatus performance.

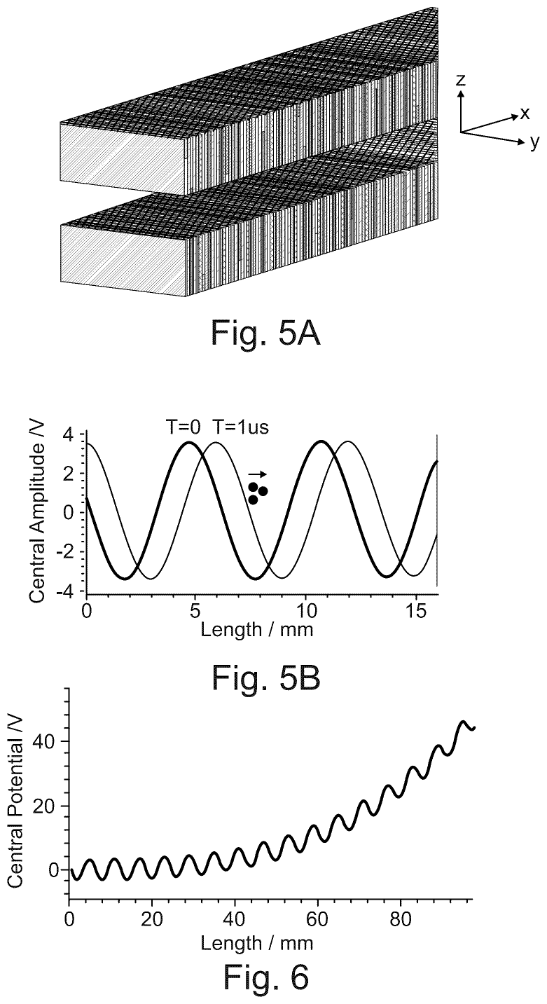

FIG. 5A shows a 10 or 15 cm long 2D stacked plate ion guide constructed with a 6 mm envelope. 4-phase travelling RF plus 2-phase trapping RF is applied. Each plate was 0.5 mm thick with 1 mm air space between plates, which is practical for such a construction without resorting to printed or etched electrodes. A 2 MHz, 200V₀₋ₚₑₐₖ trapping RF was applied with each electrode 180-degrees out of phase with its nearest neighbours. The travelling wave was then generated from a superimposed 200 KHz RF applied with a 90-degree phase shift to each subsequent electrode. An opposing DC gradient was further generated as an analytical function and superimposed, to simplify calculations rather than marking out each electrode individually.

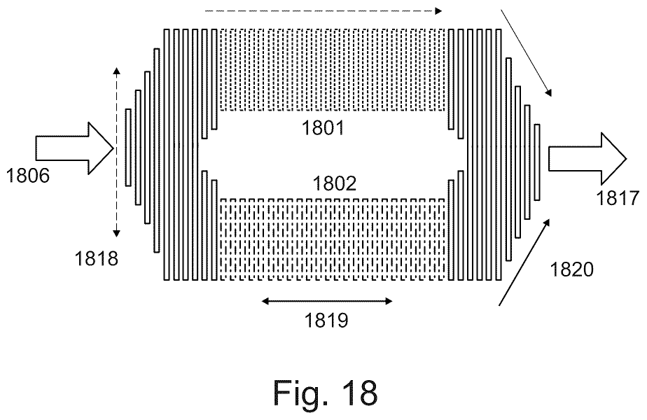

FIG. 5B also shows the structure of the travelling wave, produced down the centre of the channel by the 4-phase 50V, 200 KHz RF. The movement of the phase in 1 microsecond is also shown, as well as the motion of travel of ions influenced by the wave. A separate plot is also presented showing the travelling wave superimposed upon a 50V DC curve following a ^4 function. The gradient may be any non-linear function, though in these simulations power functions of 2-4 were used. This is similar in some respects to U.S. Pat. No. 8,841,608 B2, except with a non-linear DC gradient provided; a linear gradient having only a single retarding force, would not be able to separate ions except as a filter, or by drift velocity as a mobility device. A linear DC gradient would oppose the T-Wave induced ion motion, for example slowing ions down, so in U.S. Pat. No. 8,841,608 B2 is used to increase residence time in a mobility separator, but the separation is via ion mobility. The T-Wave will push ions up a linear gradient until they exit, or for high m/z ions without sufficient T-Wave force, the DC will push them out the other way (filtering them), but there is no settling of ions of different axial positions. Thus, in embodiments of the present disclosure, the potential gradient is preferably non-linear to provide separation. However, as discussed subsequently with reference to FIGS. 17A-17C, separation can be achieved with an axially-varied pseudopotential force in conjunction with a linear potential gradient.

In generalised terms, the arrangements in FIGS. 5A-5B can be described as having a separation region that extends in a third direction (z) that is different to the first (the x direction, also described as the separation direction) and second (y) directions. A length of the separation region in the third direction is less than a length of the separation region in the first direction and/or the second direction. For example, the apparatus of the present disclosure may be relatively thin in the z-direction while being relatively large in the x-and/or y-directions. Such apparatus may have opposing parallel planar surfaces defining a relatively thin, planar separation region between. The width of the separation region in the z-direction could be less than 50%, less than 40%, less than 30%, less than 20% or less than 10% of the length of the separation region in the x- and/or y-directions. A planar carpet structure could be provided. A planar or substantially planar electrode arrangement could be provided with a separation region adjacent to and defined by the electrodes of the electrode arrangement.

In FIGS. 5A-5B, the first direction is shown as being perpendicular to the second direction, and the first and second directions are shown as being perpendicular to a third direction. There is no requirement for the x, y and z directions to be orthogonal. A non-orthogonal geometry could instead be used.

FIGS. 5A-5B show an embodiment that separates ions in the x-direction through the combination of opposing a travelling wave with a curved DC gradient. While ions can spread in the y-direction, as this structure does not restrict them. However, ions are relatively confined in the z-direction, because a confining RF potential constrains the ions. The height of the system in the z-direction may therefore be relatively small to allow penetration of travelling waves to the middle. The embodiment of FIGS. 5A-5B can be adapted with additional forces to demonstrate the orthogonal manipulation of ion motion in the y-direction.

FIG. 6 shows the instantaneous potential across the central axis generated by a 50V, 200 KHz travelling wave and superimposed DC curve (of the form 50V*Length^3).

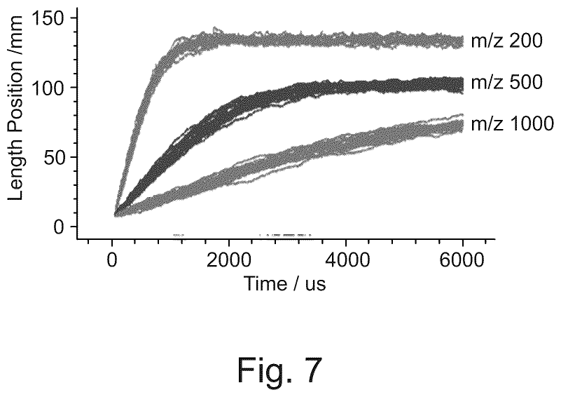

FIG. 7 shows the motion of bunches of various m/z ions through a 150 mm long separation device after being spawned near the entrance, showing the simulated ion trajectories and settling of ions in differing regions of the device. It can be seen that the differing m/z ions reach equilibrium at different axial positions, with the lowest m/z ions being most influenced by the travelling wave and thus travelling closest to the exit. Higher m/z ions are less affected by the travelling wave and therefore come to rest further from the exit. In this simulation, both travelling wave (T-Wave) and DC gradient amplitudes were set to 40V, with the applied T-Wave being 40V@200 KHZ and the DC: 40V ^4 Trend. The pressure was set to 1 mbar. Even with these strong fields, the ions may be seen to occupy a relatively wide axial spread, so that the device could function crudely as a mass analyser as well as providing good performance in the role of a low-resolution pre-separator. For instance, a resolution of at least 5 or at least 10 can be attained. In some embodiments, resolution may exceed 50 or may be as high as 100.

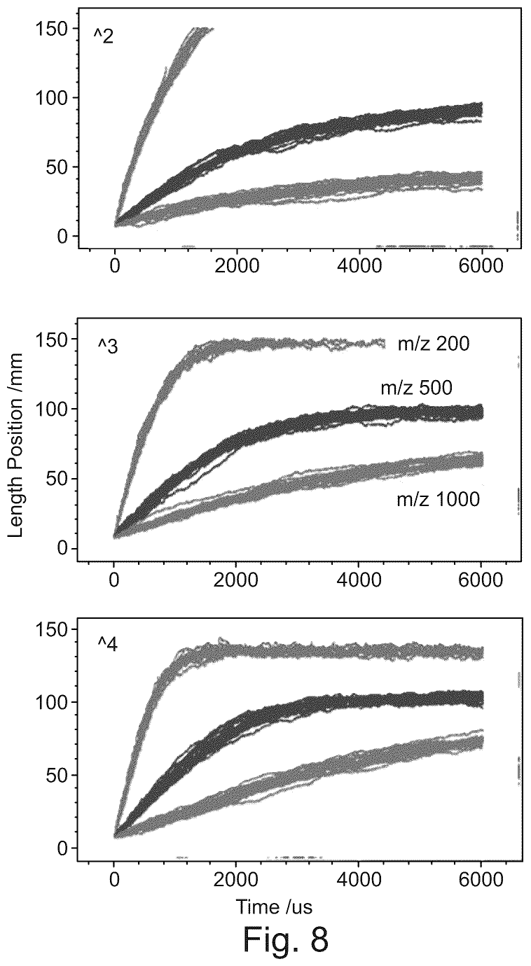

FIG. 8 shows the influence of different DC power functions of ion settling points, showing the shift of ion equilibria towards the exit of the trap. The applied T-Wave was 40V@200 KHZ, DC: 40V, and the pressure was 1 mbar. Higher power functions create a stronger gradient near the exit and thus better constrain ions from leaving for the same applied DC, at the cost of leaving a wider low field region where ions of different m/z are separated more poorly. Since in a physical device the DC amplitude may reach ˜200V without great issue, a less sharp function may be used. There is however also some advantage that higher functions push ions closer to the exit, and thus reduce the delay for released ions to exit the system. It should be noted that for a real DC gradient derived by a resistor chain, the DC function may not necessarily be a smooth polynomial but may instead be stepped in appearance (e.g. a piecewise function that loosely approximates a curve) and limited in accuracy to the quality and range of available resistors.

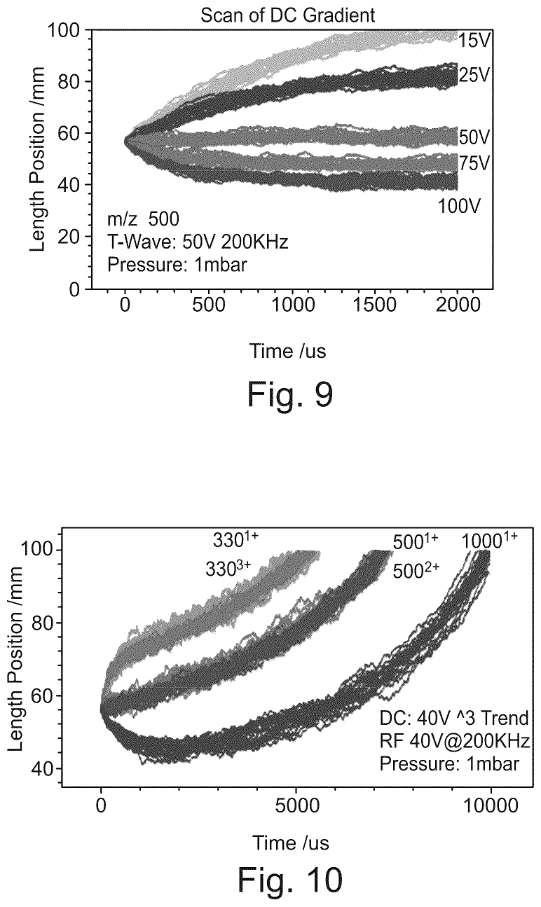

In FIG. 9, the device length is reduced to 10 cm, and the amplitudes of the travelling wave and DC gradient were scanned. Movements of m/z 500 ions from a central starting point were then tracked until the equilibrium point (or ion escape) is reached. As might be expected, a high DC gradient amplitude pushes the equilibrium point backwards down the device whilst a high T-Wave amplitude advances it, eventually overcoming the gradient and ejecting ions from the device. Whilst not shown in FIG. 9, it is possible for the DC gradient to push ions out of the rear of the device in simulations. A real system could readily be terminated by a DC barrier provided by any suitable electrode of an electrode arrangement.

One method of sequentially releasing ions from a separation region is to scan the DC gradient down. However, alternatively, the T-Wave could be increased. In some embodiments, both could be performed together to maximise the applied fields without incurring radial ion losses.

In FIG. 10 ions of various m/z and charge state, spawned in the middle of the device, are tracked as the DC gradient is decreased linearly from 40V to ground over 10 ms. This is faster than the preferred real cycle time, which is dependent on separator resolution but will be at least 50-100 ms to allow a fast mass analyser to take 10-20 spectra at different mass positions. Nevertheless, the illustrated timescales are sufficient for demonstrating the working principles of the apparatus. It was recorded that of the m/z 200-1000 range, m/z 200 emerges very rapidly, then there is a large gap to m/z 330 which emerge at 5 ms, whilst m/z 500-1000 emerge in the last 3 ms of the scan. A non-linear drop of the DC gradient could be provided (i.e. the opposing potential gradient may be time-varying) to balance this non-linearity of ion emergence, and/or the exit potential may be calibrated and set for each mass window.

The emergence time of the ions appears in simulation to be substantially independent of charge state. That is, the reduced ion mobility of a heavier doubly or triply charge ion did not make a difference to the exit time. This may be advantageous, since little information is needed to avoid inadvertently missing different charge states. A corollary of this is that it is difficult to discriminate against unwanted charge states, such as singly charged background ions. Therefore, if it is desired to discriminate against unwanted charge states, then further filtering may be performed.

The simulations described above were all performed with a collision model equivalent to 1 mbar nitrogen. This high pressure dampens ion energy and minimises dispersion and ion losses. Some losses of lower m/z ions were observed with high travelling wave amplitudes and lower pressures, which may be ascribed to the radial field perturbation generated by the travelling wave. It will be recognised that various pressures can be used in embodiments of the disclosure, with a vacuum being maintained in the separation regions of some embodiments.

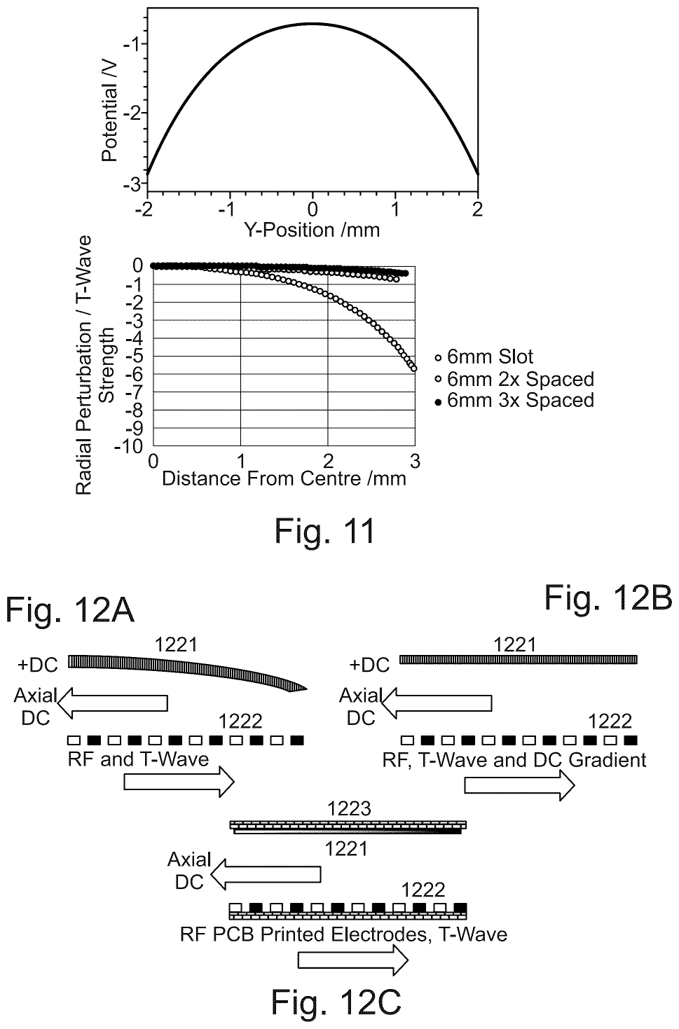

FIG. 11 shows a radial transient DC potential at the worst axial position, where for a 40V T-Wave there is a 2V pull on the ions. In this simulation, this is enough to overwhelm the trapping pseudopotential and remove ions from the device, unless an appropriate gas pressure is present to dampen the radial motion (such that mean free path <<3 mm). In the top of FIG. 11, a radial field perturbation is induced by a travelling wave, which pulls ions from the centre of device. In the bottom of FIG. 11, a decrease in radial perturbation is shown, normalised to axial T-Wave amplitude, with the same T-Wave phase applied to 2 or 3 sequential plates to enhance field penetration.

It is possible to reduce this radial perturbation, which arises from the strong field between electrodes being smoothed out towards the central axis. One method, also shown in FIG. 11, is to increase the number of consecutive electrodes with the same T-Wave phase applied, which increases the penetration to the centre without proportionally increasing the perturbation. Another method is to reduce the field steps between electrodes, by having many more phases to the travelling wave than 4, for example 8, 12 or 24. The time-varying potentials described herein can be multi-phase potentials. It is also possible to increase the frequency of the travelling wave RF, though this also reduces the axial pseudopotential force. The amplitudes of T-Wave and DC gradient may be dropped to a level such that low m/z will always survive, but separation performance may suffer.

It is known that strong DC gradients and travelling waves may induce fragmentation of ions, particularly at low pressure. Particularly for fragile multiply charged ions, field amplitudes may be reduced to preserve fragile ions.

### 2D Planar Devices

Because many of the devices described herein operate in a rough vacuum region, the devices may be merged with the same device that initially collects ions from an inlet capillary.

While the above-described embodiments are described as having a stacked ring ion guide geometry, auxiliary electrodes or segmented electrodes can be used to cause ions to spread in directions perpendicular to the axis of the stacked rings (e.g. to cause ions to occupy a planar region within the stacked rings or to occupy a substantially cylindrical volume within the stacked rings). Nevertheless, moving away from stacked rings to a more planar construction may allow greater volumes and thus higher ion capacities. Such planar structures, including RF carpets, either facing one another or using a DC counter electrode to pin ions to an RF pseudopotential plane, along with application to initial ion capture and focusing, are described in GB 2209555.8, GB 2213536.2 and GB 2217040.1, the disclosures of which are incorporated herein by reference.

FIGS. 12A-12C show examples of RF carpet device layouts suitable for application of both travelling wave and an opposing DC. In some embodiments, T-Waves are applied on trapping RF electrodes, because whilst it is possible to apply a travelling wave to a counter electrode (if suitably segmented), the ions generally sit closer to the RF electrodes and a top-down travelling wave will be greatly smoothed out. The opposing axial DC however may be provided by other electrodes on the same surface of the separation device as the RF electrodes, but may also be sourced from the counter electrode, either by changing the distance of the electrode from the RF carpet, or by segmentation and application of suitably divided DC potential.

The various electrode arrangements of FIGS. 12A-12C include a counter electrode 1221 and RF electrodes 1222. In FIGS. 12A-12C, each of the counter electrodes 1221 opposes the RF electrodes 1222. The electrode arrangements of FIGS. 12A-12C are ion carpet style structures for application of both travelling wave (applied to RF electrodes 1222) and opposing axial DC sourced from (a) shaped counter electrode 1221, (b) segmented RF electrodes 1222 and c) segmented counter-electrode 1221. Combinations of these three options can be provided.

In FIG. 12A, an axial DC provided by the shaped counter electrode opposes T-Waves provided by the RF electrodes 1222. RF potentials can provide confinement in the up/down direction. In FIG. 12B, the RF electrodes 1222 have RF, T-Wave and DC gradient applied. In FIG. 12C, the counter electrode 1221 is provided on a PCB 1223 and comprises printed electrodes with a resistive DC gradient, while the RF electrodes 1222 are RF PCB printed electrodes that apply a T-Wave.

FIGS. 12A-12C only show cross-sections of the electrode arrangement in a single plane. The electrode arrangements of FIGS. 12A-12C may be configured such that ions are able to move in a direction perpendicular to the plane of the cross sections.

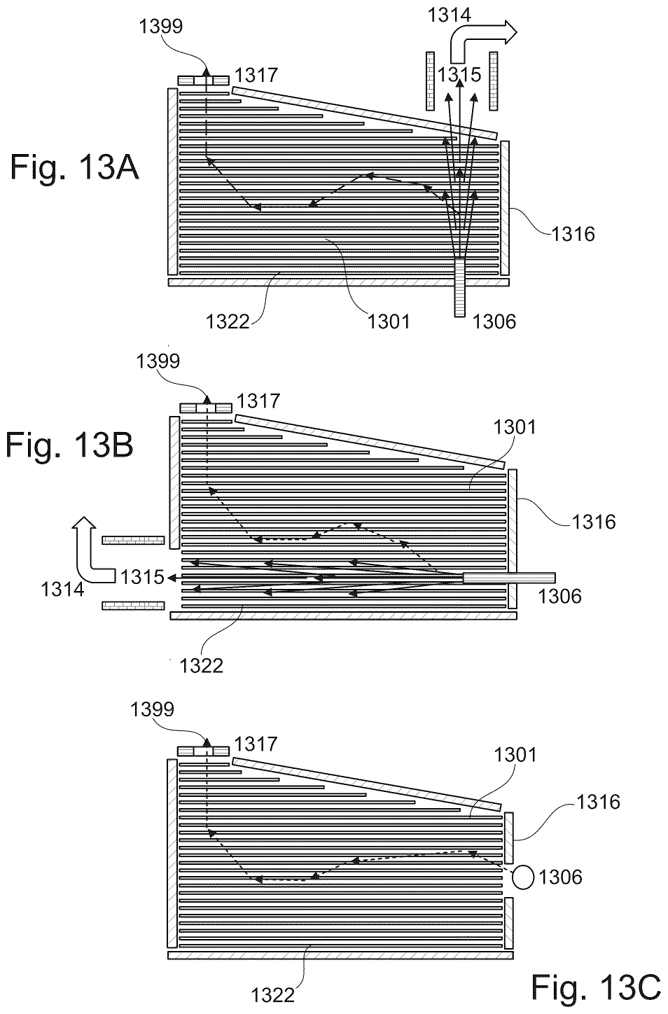

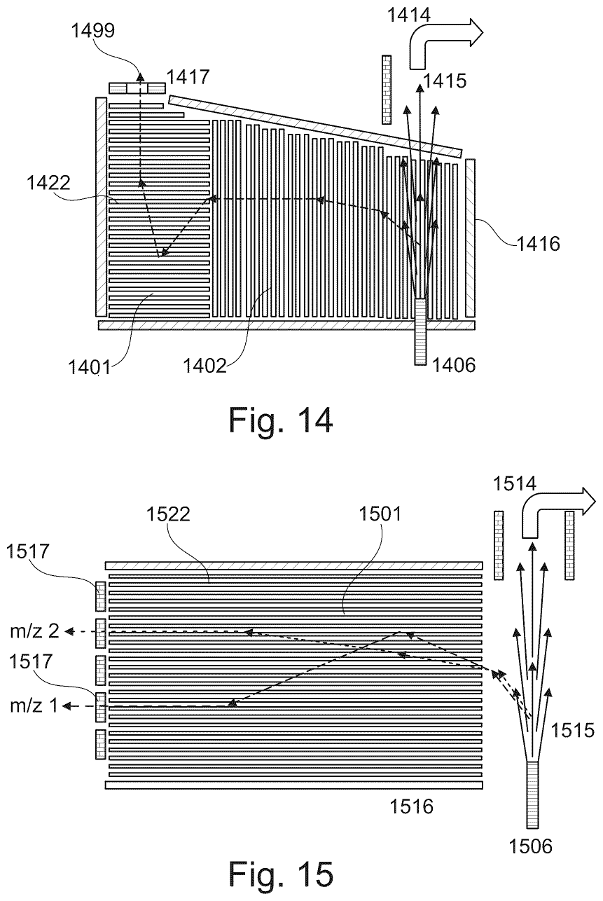

FIGS. 13A-13C and 14 show plan views of structures that can incorporate such electrode arrangements. FIGS. 13A-13C show the integration of the above-described concepts into a first vacuum region of a mass spectrometer, showing differing capillary/jet orientations with respect to the ion guide. FIG. 14 shows an additional implementation of separation and accumulation regions by separation of DC offsets applied to RF electrodes.

FIGS. 13A-13C show several apparatuses for separating ions, each comprising an inlet capillary 1306, pumping 1314 for a gas jet 1315, a guard electrode 1316 (sometimes termed a wall), an ion outlet 1317 (exit aperture), and RF electrodes 1322. Example ion paths 1399 are also shown.

In FIG. 13A, the ions enter the separation region 1301 from the inlet 1306 in the first direction (vertically). The electrode arrangement applies potentials that cause the ions to move in the second direction (horizontally) and to separate in the first direction (vertically) before exiting in the first direction via the ion outlet 1317.

In FIG. 13B, the m/z separation direction is again the vertical direction. An orthogonal (horizontal) force is provided on the ions by virtue of the gas flow. A horizontal DC gradient or T-wave may also be provided to further control the motion of the ions in the second direction. The ions enter the separation region 1301 in the second direction and then are separated in the first direction and exit the separation region in the first direction.

Returning to the generalised terms used previously, the separation region may be configured to hold a gas and the force on the ions in the second direction may be applied by a flow of the gas through the separation region. In some cases however, the gas force alone may produce the ion movement in the second direction. This orthogonal force can be provided by the gas jet from the ion inlet (e.g. inlet 1316) or could be provided by an additional gas flow. The separation region may be configured to hold a gas (e.g. by having an enclosed housing) and the separation region may be configured such that the gas flows through the separation region in the first direction (e.g. the gas flow may have at least some component of motion, for at least a part of the ion path, in the first direction). The apparatus may have a gas inlet and a gas outlet (which may be different to the ion inlet(s) and outlet(s)) arranged such that the gas flows through the separation region in the first direction and/or the second direction. The gas inlet and/or outlet can be in the separation itself or in the accumulation region, or elsewhere.

In FIG. 13C, the ions are caused to move in the second (horizontal) direction by potentials applied by the electrode arrangement. The electrode arrangement then separates the ions in the first (vertical) direction and the ions exit the separation region 1301 in the first direction.

In generalised terms, the embodiments of FIG. 13 may be described as having separation regions that comprise an ion outlet for allowing (e.g. when a valve is opened or when a gate/guard voltage is changed or when a guiding potential guides the ions) the ions to exit the separation region. The ion outlet may be positioned at an end of the separation region in the first direction and the electrode arrangement may be configured to cause the ions to exit the separation region in the first direction. For instance, the ions may move in the first direction and separate in the first direction, with the outlet being at an extremum position in the first direction.

FIG. 14 shows an embodiment related to the embodiment of FIG. 13A, but with clearly differentiated separation and accumulation regions within the RF electrode arrangement.

The apparatus shown in FIG. 14 comprises a separation region 1401, an accumulation region 1402, an ion inlet 1406 (in the form of a capillary), pumping 1414 for jet 1415, a guard electrode 1416, an exit aperture 1417, and RF electrodes 1422. An example ion path 1499 is shown.

In the embodiments of FIGS. 13A-13C and 14, the electrode arrangements are configured to apply time-varying potentials in the separation regions 1301, 1401, to cause the ions to move in a first direction, which in the drawings is shown as the vertical direction. The electrode arrangements are also configured to apply potential gradients in the separation regions 1301, 1401. These potential gradients oppose the time-varying potentials, to separate the ions at different positions in the first direction according to the mass-to-charge ratios of the ions.

The RF electrodes 1322, 1422 are preferably (but not necessarily) elongated so that a line of electrodes forms a plane. There are either two facing RF planes, or one RF plane and a DC counter electrode, which may be shaped or incorporate separated electrodes (for example PCB printed) to generate DC gradients in either direction or to apply auxiliary AC for the travelling wave (as illustrated above with respect to FIG. 12). Ions are dragged out of the post-capillary jet and into the ion guide by an orthogonal DC gradient or T-wave. The optional guard electrodes 1316, 1416 provide DC (or RF) barriers at the edges of the device to prevent ion escape, except through the exit aperture 1316, 1417.

When an accumulation region 1402 is provided, ions first accumulate there before being transferred to the separation region 1401. Optionally, the separation process may begin in the accumulation region 1402, if a suitably aligned pseudopotential force is applied to the electrode arrangement in the accumulation region 1402. Ions may be separated and released from the separation region 1401 as previously described. In some embodiments, the separation region 1401 may be a combined accumulation/separation region, while in some embodiments these may be distinct regions (e.g. separated by gas restrictions or other walls to separate the regions).

Returning to the general terminology used previously, embodiments of the disclosure may comprise an accumulation region, configured to accumulate the ions. The electrode arrangement may be configured to: transfer the ions from the accumulation region to the separation region; and separate the ions in the separation region according to the mass-to-charge ratios of the ions; wherein the apparatus is configured to refill the accumulation region while separating the ions in the separation region. Thus, ions may be accumulated at the same time as ions are being separated, which may reduce the downtime required when re-filling the apparatus.

This accumulation region may be within the confines of the same electrode arrangement that defines the separation region or may be defined by a separate electrode arrangement. The electrode arrangement(s) of the apparatus may be configured to transfer the accumulated ions between the accumulation region and the separation region, e.g. to transfer ions from the accumulation region to the separation region or vice versa. The accumulation region may comprise an ion inlet for receiving the ions and/or an ion outlet for providing the ions to the separation region and the accumulation region may comprise a gas inlet and/or a gas outlet. The ion inlet/outlet and the gas inlet/outlet may be separate outlets of the apparatus, i.e. ions may enter and exit from a different outlet to the gas. The ion outlet(s) may comprise one or more exit aperture(s) and/or one or more ion trap(s), or the outlets could include guides or conduits to transport ions to such traps.

The ion inlet 1306, 1406 (which is shown as a capillary, but other ion inlets could be provided) and the resultant jet 1315, 1415 may be aligned to the ion guide in a wide variety of orientations, as also shown in FIG. 13. It is preferable to orient the jets 1315, 1415 so that they do not work against the m/z separation, at least near the final axis of ion equilibration and transfer, as the jet force may overpower the electric fields. In some embodiments however, the gas force may be desired as a component of the separation force, similarly to trapped ion mobility. Therefore, in the various different embodiments described herein, the ion inlet 1406, 1306 can direct ions parallel to the separation (first) direction, perpendicular to the separation direction, or at some other angle to the separation direction.

A common theme in FIGS. 13A-13C and 14 that is these embodiments each provide an additional force that is orthogonal to the jet, to pull ions out of the jet and move them to the far side of the separation region. Moreover, in FIGS. 13A-13C and 14, the ions are separated according to m/z in a first direction while being caused to move in a second direction, either due to the gas forces in the apparatus or due to potentials applied to the electrode arrangements. As noted previously, there are many ways to achieve this, for example with DC gradients applied to auxiliary electrodes, from a top counter-electrode (a shaped electrode or a multiple electrode chain), wedged or segmented RF trapping electrodes, gas inlets and/or outlets, etc. In any case, the apparatus shown in FIGS. 13 and 14 are configured to apply a force in the second direction (horizontally in these figures) to the ions to cause the ions to move in the second direction.

Hence, in general terms, the electrode arrangements described herein may be configured to apply a guiding potential in the separation region to guide (optionally under the combined influence of any gas flow) the ions towards the ion outlet(s). Additionally or alternatively, the apparatus described herein may be configured to guide (optionally under the combined influence of potentials applied by the electrode arrangement) the ions towards the ion outlet(s) using a flow of gas through the separation region. These arrangements can provide a large volume for the ions to occupy and alleviate space charge constraints.

One or more guiding electrodes may apply such a guiding potential. The one or more guiding electrodes may comprise any one or more of: one or more direct current, DC, plate electrodes (e.g. applied to a DC-only top plate PCB), wherein the guiding potential comprises a DC gradient; a shaped (e.g. wedge-shaped, or curved, with different distance between sets of electrodes) counter-electrode, wherein the guiding potential has a shape corresponding to the shaped counter-electrode (e.g. the strength of the potential varies with the distance between the ions and the electrode); a segmented counter-electrode; one or more DC electrodes mounted between a plurality of RF electrodes; a plurality of RF electrodes extending in the first and/or the second direction; and a plurality of RF electrodes configured to apply a travelling wave and/or an opposing DC potential in the separation region.

The electrode arrangement may be configured to apply the guiding potential such that the ions exit the separation region in order of the mass-to charge ratios of the ions. For example, ions could be caused to exit the separation region through a single outlet at different times in order of their m/z. Alternatively, ions could be spatially ordered and exit the separation region in order of m/z at different spatial positions. The electrode arrangement may be configured to release at least a portion of the ions from the separation region and cause the ions to exit the separation region through the ion outlet(s) by adjusting one or both of the time-varying potential and the potential gradient. This could occur by sequentially adjusting one or both of the time-varying potential and the potential gradient. For instance, ions can be released sequentially by: reducing the voltage magnitude of the opposing potential over time, or increasing the force applied by the time-varying potential, or performing both. The magnitudes of these potentials could be varied linearly or non-linearly. The electrode arrangement may be configured to apply the guiding, time-varying potential and/or the potential gradient such that the ions separate (under their combined influence) in the first direction in order of mass-to-charge ratio.

Auxiliary electrodes may also be used to provide the travelling wave (including low frequency RF-based as in U.S. Pat. No. 10,317,364 B2, though this example is not for pseudopotential generation, as it gives 4 KHz examples).

In FIGS. 13A-13C and 14, one or more operational parameters of the apparatus may be varied sequentially in time (e.g. stepped), so that ions within different m/z ranges are sequentially released from the separation region. The electrode arrangement may be configured to sequentially adjust one or both of the time-varying potential and the potential gradient. For instance, at a first point in time, ions in a first range of m/z may settle at a first position that is closer to the ion exit than a second position at which ions in a second range of m/z are settled. Then, the magnitude of the opposing potential gradient may be decreased such that the ions in the first range of m/z (i.e. those ions that are closest to the exit) pass through the exit and the ions in the second m/z range move closer towards the exit and then settle at a new position (the new position being defined by the new operational parameters after undergoing a step-change); this may be repeated until the ions in the second m/z range pass through the ion exit. This can be repeated for any number of ranges of m/z.

In addition to or instead of this reduction in the magnitude of the opposing potential gradient, the time-varying potential could be varied, for example by adjusting its frequency (noting that increasing the frequency of the travelling wave reduces the axial pseudopotential force) and/or by adjusting its magnitude. These properties of the time-varying potential can therefore be varied such that the force the time-varying potential exerts on the ions increases and hence starts to overcome the opposing potential gradient. Thus, the time-varying potential could be varied (i.e. its magnitude or frequency varied) such that the ions in the first range of m/z pass through the exit and the ions in the second m/z range move closer towards the exit and settle at a new position; this also may be repeated until the ions in the second m/z range pass through the ion exit. These processes could be supplemented by additional gating or guiding potential to cause ions to pass through the exit. Moreover, this procedure of changing the potentials in the separation can be repeated for any number of m/z ranges.

### Orthogonal Extraction

A slightly different device incorporating the separation concept is shown in FIG. 15. Instead of extraction of m/z separated ions from a single ion outlet 1317, 1417 over time as described previously, FIG. 15 shows separated ions instead being extracted orthogonally (i.e., orthogonally to the direction in which they are separated by m/z) from the separation region 1501 via a series of ion outlets (apertures) 1517. In this case, the separation is ideally solely by m/z. Ions of different m/z take different paths through the separation region and are therefore directed to the different outlets 1517. The inlet capillary 1506 is shown as being beyond the limits of the device, but a suitable DC offset may be adequate to attract ions, and that side of the device may optionally be funnelled to provide additional acceptance. The ion outlets 1517 may be traps for trapping ions of different m/z or may be conduits or funnels to guide ions towards downstream traps.

In generalised terms, the separation regions described herein may comprise a plurality of ion outlets for allowing the ions to exit the separation region. There can be two, three, four or more ion outlets, with each being used to permit ions of a respective m/z to exit the separation region. The m/z that passes through each ion exit can be adjusted or tuned, for example through appropriate selection of voltages applied by the electrode arrangements and/or by adjustment of gas flows within the separation region. Thus, ions of a given m/z could be directed to a certain outlet of the plurality of outlets under certain conditions but could be directed to a different outlet under other conditions.

The plurality of ion outlets (which may be apertures, or any type of channel/conduit to transport ions to downstream processing, such as traps) are preferably spaced apart in the first direction. Thus, the ions that separate in the first direction are divided into sets of ions having corresponding m/z. The plurality of ion outlets may be positioned along an edge (e.g. any border) of the separation region. The electrode arrangement is configured to cause the ions to exit the separation region in the second direction, for example through appropriate applied potentials.

An additional potential (e.g. a DC force) pulling ions towards the exits (i.e. horizontally in FIG. 15) may be desirable to supplement (or replace) gas forces, which may be generated in the manner described in GB2209555.8 (which is incorporated by reference): DC gradients may be applied to a DC-only top plate PCB, or a shaped counter-electrode (if RF carpet type), or additional DC electrodes mounted between the RF electrodes, or by shaping of the RF electrodes. In this example, the individual RF electrodes 1522 extend horizontally, i.e. the electrodes extend towards the exits 1517, or equivalently are orthogonal to the direction in which the plurality of exits 1517 are spaced apart. Therefore, the RF electrodes 1522 may have the travelling wave/opposing DC applied directly to them. Alternatively, a travelling wave/opposing DC may be applied to one or more electrodes of the electrode arrangement (e.g. auxiliary electrodes) or a top plate counter-electrode, to provide the force in the first direction. Where the apparatus comprises a plurality of ion outlets, guiding potentials may be applied to guide ions to the respective outlets in the manner described previously.

The apparatus of FIGS. 13A-13C, 14 and 15 share a number of common features. For example, these embodiments show related electrode structures that apply related or similar potentials.

In some embodiments, the time-varying potential comprises any one or more of: an oscillatory potential; an RF potential; a pseudopotential that varies in the first direction (e.g. the time-varying potential may be an axially varying pseudopotential); a travelling wave; and a DC travelling wave. Various combinations of these potentials can be used to drive ions against an opposing potential and thereby achieve separation.

The potential gradients described herein and/or the time-varying potentials described herein may vary non-linearly. For example, the potential gradients could vary as a non-linear function (e.g. a polynomial) of spatial position. The potential gradients could be defined by a piecewise linear approximation to a non-linear function. For example, segmented electrodes could apply local potentials that vary linearly locally while the overall potential landscape defined by all of the segments follows a generally non-linear trend with spatial position. The potential gradient is preferably a DC potential gradient but there may be some AC component. The magnitude of the time-varying potential could additionally or alternatively vary non-linearly with spatial position.

The electrode arrangements described herein may comprise a plurality of electrodes and these electrodes can be classified according to the function that they perform. For example, the electrode arrangements may comprise a first set of one or more electrodes (e.g. a counter electrode) configured to apply the potential gradient and a second set of one or more electrodes (e.g. RF electrodes) configured to apply the time-varying potential. The first and/or second set of one or more electrodes may each comprise a plurality of electrodes.

The first and second sets of one or more electrodes may be on opposite sides of the separation region. The separation region may be defined as the region directly between these sets of electrodes. The sets of electrodes may be mounted on walls of a housing of the apparatus.

In some embodiments, the first set of one or more electrodes is parallel with the second set of one or more electrodes. For example, both sets may be arranged on a planar surface. Hence, the first set of one or more electrodes may be planar or substantially planar and/or the second set of one or more electrodes may be planar or substantially planar.

The first and/or second set of one or more electrodes may comprise a plurality of electrode segments. Additionally or alternatively, the first and/or second set of one or more electrodes may be on a printed circuit board (PCB).

The first set of one or more electrodes may comprise a counter electrode. The counter electrode can be a shaped (e.g. curved) counter-electrode and the potential gradient may have a shape corresponding to the shaped counter-electrode. For example, the counter electrode may be curved, to tailor the spatial form of the applied potential.

A distance between the first set of one or more electrodes and the second set of one or more electrodes may vary along a length of the separation region. For example, one or both sets of electrodes may be curved, to tailor the spatial form of the applied potentials. Shaped counter electrodes will be closer to the ions at certain points and may thus apply stronger forces to the ions. A distance between the sets of electrodes in the third direction may be different at different positions in the first and/or second directions.

In some embodiments, the first and second sets of one or more electrodes may be arranged on a common surface or substrate. For example, both sets may be coplanar.

The first set of one or more electrodes and/or the second set of one or more electrodes may comprise any one or more of: one or more direct current, DC, plate electrodes, wherein the guiding potential comprises a DC gradient; a shaped counter-electrode, wherein the guiding potential has a shape corresponding to the shaped counter-electrode; a segmented counter-electrode; one or more DC electrodes mounted between a plurality of RF electrodes; a plurality of RF electrodes extending in the first and/or the second direction; and a plurality of RF electrodes configured to apply a travelling wave and/or an opposing DC potential in the separation region. These may be as described previously.

One or more guard electrodes may form part of the electrode arrangement. Such guard electrodes may be positioned along at least one edge of the separation region. This can ensure that ions are confined. Where an accumulation region is provided, the guard electrode(s) may additionally or alternatively be along an edge of the accumulation region.

### Ion Conveyor

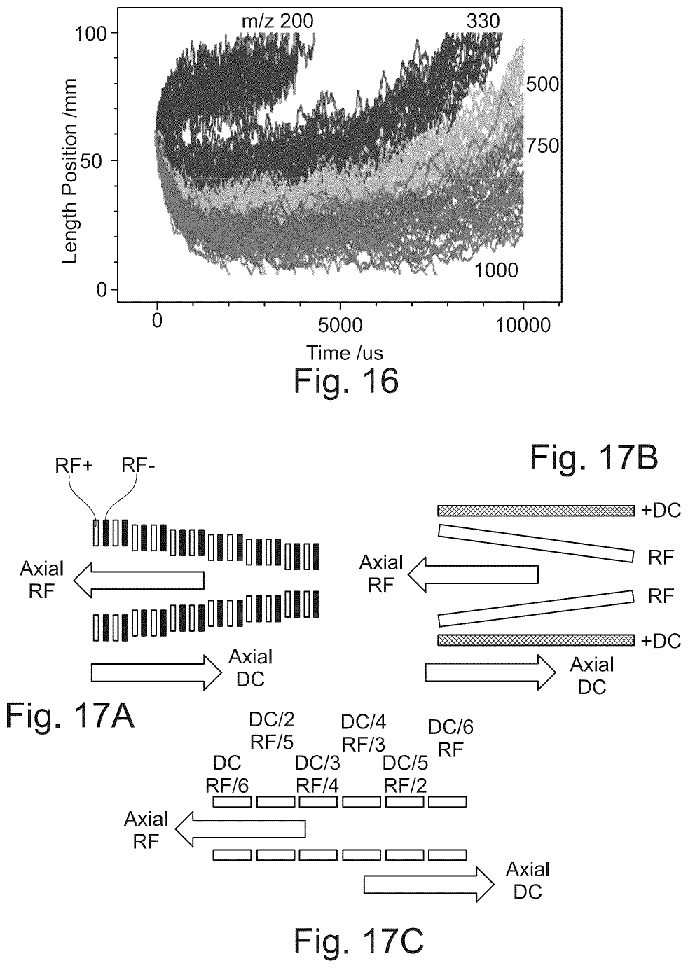

Methods have been presented to allow operation at lower pressures, such as 0.1 and 0.01 mbar. This would allow the device to operate within collision cells, or in a differentially pumped region immediately prior to a quadrupole. The apparatus described herein can operate at pressures of up to 1 mbar, up to 0.5 mbar, up to 0.1 mbar, up to 0.05 mbar, or up to 0.01 mbar. A combined trapping and travelling wave RF, similar to the ion conveyor (U.S. Pat. No. 7,375,344 B2) is considered, which is essentially the same 4-phase travelling wave as before but operating at the MHz frequency and higher voltage of a trapping RF. FIG. 16 shows a similar simulation to FIG. 10, whereby a DC gradient is ramped down over 10 ms and separated ions are allowed to emerge sequentially, only at 0.1 mbar pressure and with an ion conveyor-type travelling wave. In FIG. 16, an ion conveyor (U.S. Pat. No. 7,375,344 B2) type combined trapping RF and travelling wave are provided, with a DC: 15V ^3 trend with 10 ms ramp to ground, RF: 750V@2 MHz.

### Axially-Variable Pseudopotential Force vs Linear DC

Some embodiments of the present disclosure include a pseudopotential (Travelling Wave) that is opposed by an axially varying DC force (a curved DC gradient). However, a travelling wave is not the only way to generate an axial pseudopotential. Another way beyond using a non-linear DC, is to generate an axially varied pseudopotential force, and then the opposing DC may be a fixed force generated by a linear gradient.

Several methods for generating such effects are shown in FIGS. 17A-17C, where various non-travelling wave means of generating axial varying pseudopotential and DC gradients are shown. FIG. 17A shows ion funnel-like variation in aperture size of stacked ring guide (which may also vary spacing of electrodes, or single/double/triple spacing of auxiliary RF). FIG. 17B shows a multipole with varying r₀ of RF rods vs fixed auxiliary DC electrode (alternative is vice versa, and auxiliary RF may also be used, even applied to the same auxiliary DC electrode). FIG. 17C shows segmentation of multipole rod electrodes with varying DC and RF applied via resistive/capacitive dividers.

In more detail, FIG. 17A shows an ion funnel structure. It is known that conventional ion funnels usually need either a DC gradient or gas force to push ions through the final electrodes, where the aperture size shrinks to a similar scale as the spacing between ring electrodes. This is because the RF penetration increasingly reaches the central axis, forming a pseudopotential barrier that ions must be driven across. Normally this is greatly disadvantageous and causes fragmentation of ions. However, this effect may be harnessed in the separation devices described herein. By shrinking the envelope/inscribed radius with axial position, it should be possible to generate a broadly consistent or axially varied pseudopotential force (with some undulation). Another way to increase RF penetration is to increase the spacing between plates, similar to the S-Lens found in Exploris™ 120 and 240 mass spectrometers.

In generalised terms, the embodiment of FIG. 17A may be described as comprising a plurality of RF electrode segments. The RF electrode segments are disposed along the first direction (the direction in which ions travel and separate). The RF electrode segments may be substantially circular or ring-shaped. A radius of the RF electrode segments may vary (e.g. decrease) along the path of the ions. The strength of the pseudopotential experienced by the ions may therefore also vary along the first direction, due to the differing distance between the electrodes and the ions, i.e. the RF electrode segments may generate an axially-varying pseudopotential. Such a pseudopotential may be opposed by a DC potential (which may arise from a linear potential, i.e. a constant force, or which may be a curved potential) to separate ions.

FIG. 17B shows varying r₀ multipole rods. A plurality of linearly extending rod electrodes may surround an ion optical axis, and each rod electrode may be disposed at a tilt in such a manner that the distance from the ion optical axis increases toward the ion's traveling direction. That is, the radius r₀ of the inscribed circle of the ion guide may vary along the direction of the ion optical axis. Similar to the collision cell described in U.S. Pat. No. 7,985,951 B2, varying the r₀ of a multipole rod set may produce a type of pseudopotential gradient, whilst non-linear variation will produce a non-linear gradient. A displacement of a single electrode may be used in embodiments of the present disclosure. These need not be the trapping RF rods but may relate to penetration from auxiliary RF electrodes. Auxiliary DC electrodes may also be used, and even if they are fixed r₀ (like a cylinder around splayed RF rods), the field penetration to the centre will vary due to the change in the RF electrodes, creating a useful opposing DC gradient.

In general terms, the embodiment of FIG. 17B may be described as comprising a plurality of multipole electrodes. The multipole electrodes are disposed around the axis that extends in the first direction (the direction in which ions travel and separate). The multipole electrodes may be substantially rod-shaped. A distance between the multipole electrodes may vary (e.g. decrease) along the path of the ions. The strength of the pseudopotential experienced by the ions may therefore also vary along the first direction, due to the differing distance between the multipole electrodes and the ions, i.e. the multipole electrodes may generate an axially-varying pseudopotential. Such a pseudopotential may be opposed by a DC potential (which may arise from a linear potential, i.e. a constant force, or which may be a curved potential) to separate ions.

FIG. 17C shows segmentation of axial electrodes (either main rod or auxiliary). If separated by a capacitive divider network, it is possible for an RF amplitude to vary with axial position, similar to how a DC gradient can be produced by a resistor chain. Similar arrangements may be used to produce an axially varying travelling wave amplitude. Therefore, in generalised terms, FIG. 17C may be described as comprising a plurality of RF electrodes to which RF potentials are applied. The RF electrodes are disposed along the axis that extends in the first direction (the direction in which ions travel and separate). The magnitude of the RF potential varies along the first direction. This can be achieved using potential dividers, e.g. using a capacitive divider network. This can also provide an axially-varying pseudopotential. Such a pseudopotential may be opposed by a DC potential (which may arise from a linear potential, i.e. a constant force, or which may be a curved potential) to separate ions.

Another possible method of extraction of ions is that after initial separation and prior to extraction, the pseudopotential travelling wave is terminated and ions trapped within a series of DC trapping wells. In the case of a pulsed DC travelling wave, this would be equivalent to reducing the wave velocity to zero or near zero. The separated packets may then be extracted one by one (or one by two, etc.) by either dropping each DC barrier sequentially, or running a very slow travelling wave that acts like a moving DC force.

The travelling wave may be applied by a digital waveform, as may the trapping RF (if separate).

Axial pseudopotential barriers may be used to control the release of ions, in an m/z dependent fashion, to give a head start for slow heavy ions headed towards the orthogonal accelerator of a ToF analyser. This allows light fast ions to catch up with slow heavy ions, spatially focusing different m/z ions at the point of extraction and greatly enhancing the sensitivity of the pulser (U.S. Pat. No. 7,456,388 B2). This device, by separating ions of differing m/z in space, can also give a suitable head start to heavy ions, even by giving them a shorter flight path. This operation may be adapted due to the high pressure the device has been simulated to best operate at, and the short time differences (<10 s us).

### Switchable Ion Paths

A further embodiment of the present disclosure is shown in FIG. 18. The embodiment of FIGS. 18 includes an ion inlet 1806, an ion outlet 1817, a first switchable path 1801??, a second switchable path 1819, and a merging region 1820. Advantageously, the separation region 1801 may be in parallel with the accumulation region 1802 rather than in series (as in FIGS. 2 and 14). A beam switching device (such as described in UK patent application number GB 2209555.8) can be used to control the direction of ion flow between them. For example, the electrode arrangement may be configured to control the potentials applied by the electrodes to switch the ion paths. An advantage of this arrangement is that such a system could be switched to a beam transmission mode without requiring both empty accumulation and separation regions 1801, 1802. This arrangement may be formed out of a stacked plate electrode arrangement, with orthogonal DC gradients provided by auxiliary electrodes, or by an ion carpet with DC gradients provided from a top plate. In an alternative structure, the separation and accumulation regions may be provided in series, with a bypass put in place to facilitate easy switching to beam mode.

As shown in FIG. 14, the accumulation region can be upstream of the separation region. In such an arrangement, both the accumulation and separation regions are within the confines of the electrode arrangement. However, this is not essential, as demonstrated by FIG. 18.

Hence, in some embodiments, the accumulation region is in parallel with the separation region. The apparatus may be configured to switch between the accumulation/separation regions, or provide a bypass. For example, in some embodiments, the electrode arrangement is configured to switch between any one or more of: a first configuration in which the electrode arrangement is configured to cause the ions to enter the accumulation region without passing through the separation region; a second configuration in which the electrode arrangement is configured to cause the ions to enter the separation region without passing through the accumulation region; and a third configuration in which the electrode arrangement is configured to cause the ions to enter the accumulation region and accumulate therein and to cause the accumulated ions to transfer from the accumulation region to the separation region. Switching between these different modes of operation can be controlled with appropriate electrode potentials. For example, the electrode arrangement may comprise a variable barrier (e.g. a DC barrier) between the accumulation region and the separation region. Various potential gradients could be applied to the electrode arrangements to transfer ions between the different regions.

It will be understood that many variations may be made to the above systems and methods whilst retaining the advantages noted previously. For example, where specific components have been described, alternative components can be provided that provide the same or similar functionality.

For example, in some embodiments, it may be beneficial to have two separation devices/regions in series. One could perform a rough separation and the other could perform a fine separation. An advantage is that the second separator need not suffer from high space charge or require voltage settings suitable for a wide m/z range, so better resolution may be possible with a lower chance of negative side effects like fragmentation. Hence, in general terms, there may be provided a first separation region, with the apparatus further comprising a second separation region in series with the first separation region. The first separation region may be configured to perform a relatively coarse separation of the ions and the second separation region may be configured to perform a relatively fine separation of the ions. Differing resolutions could be used for the relatively coarse and relatively fine separations. For example, the first separation region could have a resolution of approximately 5 and the second separation region could have a resolution of approximately 30. Whilst both are fairly coarse, the second separation region may have a resolution that is at least 2× or 3× greater than the resolution of the first separation region. The second separation region may be downstream of the first separation region.

Most embodiments described herein show the separation region being sandwiched between two opposing electrode structures. However, in some embodiments, the first and second sets of electrodes that provide the time-varying potential and the opposing potential gradient could be distributed along a single surface (e.g. a two-dimensional planar surface), with some electrodes providing a repulsive force and other electrodes providing an attractive force. The time-varying potential and opposing gradient could be provided by a series of electrodes on a single surface (e.g. a flat surface). In some embodiments, first and second sets of electrodes could be on surfaces oriented perpendicularly to one another.

In further embodiments, the present disclosure provides devices that do not necessarily cause ions to move in a second direction that is orthogonal to the first direction in which the ions separate. For example, the disclosure also provides an apparatus, comprising:
a separation region configured to receive ions, the separation region extending in a first direction and suitable for separating ions according to the mass-to-charge ratios of the ions;
an electrode arrangement configured to confine the ions in the separation region, wherein:
   the electrode arrangement is configured to apply a time-varying potential in the separation region to cause the ions to move in the first direction; and
   the electrode arrangement is configured to apply a potential gradient in the separation region, the potential gradient opposing the time-varying potential, such that the ions are separated at different positions in the first direction according to the mass-to-charge ratios of the ions; and
an accumulation region, configured to accumulate the ions, the accumulation region being in parallel with the separation region.

The electrode arrangement may be configured to switch between any one or more of:
a first configuration in which the electrode arrangement is configured to cause the ions to enter the accumulation region without passing through the separation region;
a second configuration in which the electrode arrangement is configured to cause the ions to enter the separation region without passing through the accumulation region; and
a third configuration in which the electrode arrangement is configured to cause the ions to enter the accumulation region and accumulate therein and to cause the accumulated ions to transfer from the accumulation region to the separation region. Such an apparatus may work in a similar manner to the other embodiments described herein.

Moreover, it will be appreciated that some embodiments provide apparatuses that provide advantageous ways of generating potentials within the various regions of the apparatuses. For example, there is also provided: an apparatus, comprising:
a separation region configured to receive ions, the separation region extending in a first direction and suitable for separating ions according to the mass-to-charge ratios of the ions;
an electrode arrangement configured to confine the ions in the separation region, wherein:
   the electrode arrangement is configured to apply a time-varying potential in the separation region to cause the ions to move in the first direction; and
   the electrode arrangement is configured to apply a potential gradient in the separation region, the potential gradient opposing the time-varying potential, such that the ions are separated at different positions in the first direction according to the mass-to-charge ratios of the ions.

In such embodiments, the electrode arrangement could comprise any of the electrode arrangements shown in FIGS. 12A-12C and/or FIG. 17, for example, to generate appropriate fields for manipulating ions (e.g. causing ions to enter a particular region, or causing ions to be transported and/or separated as they move through a particular region, or for causing ions to exit a particular region). The electrode arrangements in FIGS. 2, 5A, 13, 14 and/or 15 could also be used.

Each feature disclosed in this specification, unless stated otherwise, may be replaced by alternative features serving the same, equivalent or similar purpose. Thus, unless stated otherwise, each feature disclosed is one example only of a generic series of equivalent or similar features.

As used herein, including in the claims, unless the context indicates otherwise, singular forms of the terms herein are to be construed as including the plural form and, where the context allows, vice versa. For instance, unless the context indicates otherwise, a singular reference herein including in the claims, such as “a” or “an” (such as an electrode or a potential) means “one or more” (for instance, one or more electrodes, or one or more potentials). Throughout the description and claims of this disclosure, the words “comprise”, “including”, “having” and “contain” and variations of the words, for example “comprising” and “comprises” or similar, mean that the described feature includes the additional features that follow, and are not intended to (and do not) exclude the presence of other components.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

Any steps described in this specification may be performed in any order or simultaneously unless stated or the context requires otherwise. Moreover, where a step is described as being performed after a step, this does not preclude intervening steps being performed.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

### CLAUSES

1. An apparatus for separating ions according to the mass-to-charge ratios of the ions, comprising:
   a separation region configured to receive the ions, the separation region extending in a first direction and a second direction that is different to the first direction; and
   an electrode arrangement configured to confine the ions in the separation region, wherein:
   the electrode arrangement is configured to apply a time-varying potential in the separation region to cause the ions to move in the first direction;
   the electrode arrangement is configured to apply a potential gradient in the separation region, the potential gradient opposing the time-varying potential, such that the ions are separated at different positions in the first direction according to the mass-to-charge ratios of the ions; and
   the apparatus is configured to apply a force in the second direction to the ions to cause the ions to move in the second direction.
2. The apparatus of clause 1, wherein the separation region extends in a third direction that is different to the first and second directions, and wherein a length of the separation region in the third direction is less than a length of the separation region in the first direction and/or the second direction.
3. The apparatus of clause 1 or clause 2, wherein the first direction is substantially perpendicular to the second direction, and optionally wherein the first and second directions are substantially perpendicular to a third direction.
4. The apparatus of any preceding clause, wherein the separation region comprises an ion outlet for allowing the ions to exit the separation region.
5. The apparatus of clause 4, wherein the ion outlet is positioned at an end of the separation region in the first direction.
6. The apparatus of clause 4 or clause 5, wherein the electrode arrangement is configured to cause the ions to exit the separation region in the first direction.
7. The apparatus of any preceding clause, wherein the separation region comprises a plurality of ion outlets for allowing the ions to exit the separation region.
8. The apparatus of clause 7, wherein the ion outlets of the plurality of ion outlets are spaced apart in the first direction.
9. The apparatus of clause 7 or clause 8, wherein the electrode arrangement is configured to cause the ions to exit the separation region in the second direction.
10. The apparatus of any of clauses 7 to 9, wherein the plurality of ion outlets are positioned along an edge of the separation region.
11. The apparatus of any of clauses 4 to 10, wherein the ion outlet(s) comprises one or more exit aperture(s) and/or one or more ion trap(s).
12. The apparatus of any of clauses 4 to 11, wherein:
   the electrode arrangement is configured to apply a guiding potential in the separation region to guide the ions towards the ion outlet(s); and/or
   the apparatus is configured to guide the ions towards the ion outlet(s) using a flow of gas through the separation region.
13. The apparatus of clause 12, wherein the electrode arrangement comprises one or more guiding electrodes configured to apply the guiding potential, the one or more guiding electrodes comprising any one or more of:
   one or more direct current, DC, plate electrodes, wherein the guiding potential comprises a DC gradient;
   a shaped counter-electrode, wherein the guiding potential has a shape corresponding to the shaped counter-electrode;
   a segmented counter-electrode;
   one or more DC electrodes mounted between a plurality of RF electrodes;
   a plurality of RF electrodes extending in the first and/or the second direction; and
   a plurality of RF electrodes configured to apply a travelling wave and/or an opposing DC potential in the separation region.
14. The apparatus of clause 12 or clause 13, wherein the electrode arrangement is configured to apply the guiding potential such that the ions exit the separation region in order of the mass-to charge ratios of the ions.
15. The apparatus of any of clauses 4 to 14, wherein the electrode arrangement is configured to release at least a portion of the ions from the separation region and cause the ions to exit the separation region through the ion outlet(s) by adjusting one or both of the time-varying potential and the potential gradient.
16. The apparatus of clause 15, wherein the electrode arrangement is configured to sequentially adjust one or both of the time-varying potential and the potential gradient.
17. The apparatus of any preceding clause, wherein the separation region is configured to hold a gas and wherein the force in the second direction is applied by a flow of the gas through the separation region.
18. The apparatus of any preceding clause, wherein the separation region is configured to hold a gas and wherein the separation region is configured such that the gas flows through the separation region in the first direction.
19. The apparatus of clause 17 or clause 18, comprising a gas inlet and a gas outlet arranged such that the gas flows through the separation region in the first direction and/or the second direction.
20. The apparatus of any preceding clause, wherein one or more electrodes of the electrode arrangement are configured to apply the force in the second direction.
21. The apparatus of clause 20, wherein the potential gradient is a first potential gradient of a first potential applied by a first set of one or more electrodes of the electrode arrangement and wherein a second set of one or more electrodes of the electrode arrangement are configured to apply a second potential in the separation region to apply the force in the second direction.
22. The apparatus of clause 21, wherein the second potential comprises a DC gradient in the second direction.
23. The apparatus of clause 21 or clause 22, wherein the second potential comprises a travelling wave that travels in the second direction.
24. The apparatus of any preceding clause 1, wherein the time-varying potential comprises an oscillatory potential.
25. The apparatus of any preceding clause, wherein the time-varying potential comprises an RF potential.
26. The apparatus of any preceding clause, wherein the time-varying potential comprises a pseudopotential that varies in the first direction.
27. The apparatus of any preceding clause, wherein the time-varying potential comprises a travelling wave.
28. The apparatus of any preceding clause, wherein the time-varying potential comprises a DC travelling wave.
29. The apparatus of any preceding clause, wherein the potential gradient and/or the time-varying potential varies non-linearly.
30. The apparatus of any preceding clause, wherein the potential gradient is a DC potential gradient.
31. The apparatus of any preceding clause, wherein the electrode arrangement comprises a first set of one or more electrodes configured to apply the potential gradient and a second set of one or more electrodes configured to apply the time-varying potential.
32. The apparatus of clause 31, wherein the first and second sets of one or more electrodes are on opposite sides of the separation region.
33. The apparatus of clause 31 or clause 32, wherein the first set of one or more electrodes is substantially parallel with the second set of one or more electrodes.
34. The apparatus of any of clauses 31 to 33, wherein the first set of one or more electrodes is substantially planar and/or wherein the second set of one or more electrodes is substantially planar.
35. The apparatus of any of clauses 31 to 34, wherein the first and/or second set of one or more electrodes comprises a plurality of electrodes.
36. The apparatus of any of clauses 31 to 35, wherein the first and/or second set of one or more electrodes comprises a plurality of electrode segments.
37. The apparatus of any of clauses 31 to 36, wherein the first and/or second set of one or more electrodes are on a printed circuit board, PCB.
38. The apparatus of any of clauses 31 to 37, wherein the first set of one or more electrodes comprises a counter electrode.
39. The apparatus of clause 38, wherein the counter electrode is a shaped counter-electrode, wherein the potential gradient has a shape corresponding to the shaped counter-electrode.
40. The apparatus of any of clauses 31 to 39, wherein a distance between the first set of one or more electrodes and the second set of one or more electrodes varies along a length of the separation region.
41. The apparatus of any of clauses 31 to 39, wherein the first and second sets of one or more electrodes are substantially coplanar.
42. The apparatus of any of clauses 31 to 41, wherein the first set of one or more electrodes and/or the second set of one or more electrodes comprises any one or more of:
   one or more direct current, DC, plate electrodes, wherein the guiding potential comprises a DC gradient;
   a shaped counter-electrode, wherein the guiding potential has a shape corresponding to the shaped counter-electrode;
   a segmented counter-electrode;
   one or more DC electrodes mounted between a plurality of RF electrodes;
   a plurality of RF electrodes extending in the first and/or the second direction; and
   a plurality of RF electrodes configured to apply a travelling wave and/or an opposing DC potential in the separation region.
43. The apparatus of any preceding clause, wherein the electrode arrangement comprises one or more guard electrodes positioned along at least one edge of the separation region.
44. The apparatus of any preceding clause, wherein: the separation region is a vacuum region; and/or the separation region is at a lower pressure than an upstream region of the apparatus and/or a downstream region of the apparatus.
45. The apparatus of any preceding clause, further comprising an accumulation region, configured to accumulate the ions.
46. The apparatus of clause 45, wherein the electrode arrangement is configured to transfer the accumulated ions from the accumulation region to the separation region.
47. The apparatus of any of clauses 45 to 46, wherein the accumulation region comprises an ion inlet for receiving the ions and/or an ion outlet for providing the ions to the separation region.
48. The apparatus of any of clauses 45 to 47, wherein the accumulation region comprises a gas inlet and/or a gas outlet.
49. The apparatus of any of clauses 45 to 48, wherein the accumulation region is upstream of the separation region.
50 The apparatus of any of clauses 45 to 49, wherein the accumulation region is in parallel with the separation region.
51. The apparatus of clause 50, wherein the electrode arrangement is configured to switch between any one or more of:
   a first configuration in which the electrode arrangement is configured to cause the ions to enter the accumulation region without passing through the separation region;
   a second configuration in which the electrode arrangement is configured to cause the ions to enter the separation region without passing through the accumulation region; and
   a third configuration in which the electrode arrangement is configured to cause the ions to enter the accumulation region and accumulate therein and to cause the accumulated ions to transfer from the accumulation region to the separation region.
52. The apparatus of clause 51, wherein the electrode arrangement is configured to apply a variable DC barrier between the accumulation region and the separation region.
53. The apparatus of any of clauses 45 to 52, wherein the electrode arrangement is configured to:
   transfer the ions from the accumulation region to the separation region; and
   separate the ions in the separation region according to the mass-to-charge ratios of the ions;
   wherein the apparatus is configured to refill the accumulation region while separating the ions in the separation region.
54. The apparatus of any preceding clause, wherein the separation region is a first separation region, the apparatus further comprising a second separation region in series with the first separation region.
55. The apparatus of clause 54, wherein the first separation region is configured to perform a relatively coarse separation of the ions and the second separation region is configured to perform a relatively fine separation of the ions.
56. A mass spectrometry system comprising:
   the apparatus for separating ions of any preceding clause; and
   a mass filter downstream of the apparatus, the mass filter configured to receive the ions from the apparatus.
57. The mass spectrometry system of clause 56, further comprising a mass analyser configured to receive the ions from the mass filter or to receive ions derived from the ions from the mass filter, and to perform mass analysis on the received ions.

1. An apparatus for separating ions according to mass-to-charge ratios of the ions, comprising:
a separation region configured to receive the ions, the separation region extending in a first direction and a second direction that is different to the first direction; and
an electrode arrangement configured to confine the ions in the separation region, wherein:
the electrode arrangement is configured to apply a time-varying potential in the separation region to cause the ions to move in the first direction;
the electrode arrangement is configured to apply a potential gradient in the separation region, the potential gradient opposing the time-varying potential, such that the ions are separated at different positions in the first direction according to mass-to-charge ratios of the ions; and
the apparatus is configured to apply a force in the second direction to the ions to cause the ions to move in the second direction.

2. The apparatus of claim 1, wherein the separation region extends in a third direction that is different to the first and second directions, and wherein a length of the separation region in the third direction is less than a length of the separation region in the first direction and/or the second direction.

3. The apparatus of claim 1, wherein the first direction is substantially perpendicular to the second direction, and optionally wherein the first and second directions are substantially perpendicular to a third direction.

4. The apparatus of claim 1, wherein the separation region comprises an ion outlet for allowing the ions to exit the separation region, preferably wherein the ion outlet is positioned at an end of the separation region in the first direction, more preferably wherein the electrode arrangement is configured to cause the ions to exit the separation region in the first direction.

5. The apparatus of claim 1, wherein the separation region comprises a plurality of ion outlets for allowing the ions to exit the separation region, preferably wherein the ion outlets of the plurality of ion outlets are spaced apart in the first direction.

6. The apparatus of claim 5, wherein the electrode arrangement is configured to cause the ions to exit the separation region in the second direction.

7. The apparatus of claim 5, wherein the plurality of ion outlets are positioned along an edge of the separation region.

8. The apparatus of claim 4, wherein:
the electrode arrangement is configured to apply a guiding potential in the separation region to guide the ions towards the ion outlet(s); and/or
the apparatus is configured to guide the ions towards the ion outlet(s) using a flow of gas through the separation region.

9. The apparatus of claim 8, wherein the electrode arrangement comprises one or more guiding electrodes configured to apply the guiding potential, the one or more guiding electrodes comprising any one or more of:
one or more direct current, DC, plate electrodes, wherein the guiding potential comprises a DC gradient;
a shaped counter-electrode, wherein the guiding potential has a shape corresponding to the shaped counter-electrode;
a segmented counter-electrode;
one or more DC electrodes mounted between a plurality of RF electrodes;
a plurality of RF electrodes extending in the first and/or the second direction; and
a plurality of RF electrodes configured to apply a travelling wave and/or an opposing DC potential in the separation region.

10. The apparatus of claim 8, wherein the electrode arrangement is configured to apply the guiding potential such that the ions exit the separation region in order of the mass-to charge ratios of the ions.

11. The apparatus of claim 4, wherein the electrode arrangement is configured to release at least a portion of the ions from the separation region and cause the ions to exit the separation region through the ion outlet(s) by adjusting one or both of the time-varying potential and the potential gradient.

12. The apparatus of claim 11, wherein the electrode arrangement is configured to sequentially adjust one or both of the time-varying potential and the potential gradient.

13. The apparatus of claim 1, wherein the separation region is configured to hold a gas and wherein the force in the second direction is applied by a flow of the gas through the separation region.

14. The apparatus of claim 13, comprising a gas inlet and a gas outlet arranged such that the gas flows through the separation region in the first direction and/or the second direction.

15. The apparatus of claim 1, wherein one or more electrodes of the electrode arrangement are configured to apply the force in the second direction.

16. The apparatus of claim 15, wherein the potential gradient is a first potential gradient of a first potential applied by a first set of one or more electrodes of the electrode arrangement and wherein a second set of one or more electrodes of the electrode arrangement are configured to apply a second potential in the separation region to apply the force in the second direction, preferably wherein the second potential comprises a DC gradient in the second direction and/or a travelling wave that travels in the second direction.

17. The apparatus of claim 1, wherein the time-varying potential comprises any one or more of:
an oscillatory potential;
an RF potential;
a pseudopotential that varies in the first direction;
a travelling wave; and
a DC travelling wave.

18. The apparatus of claim 1, wherein the potential gradient and/or the time-varying potential varies non-linearly.

19. The apparatus of claim 1, wherein the potential gradient is a DC potential gradient.

20. The apparatus of claim 1, wherein the electrode arrangement comprises a first set of one or more electrodes configured to apply the potential gradient and a second set of one or more electrodes configured to apply the time-varying potential.

21. The apparatus of claim 20, wherein:
the first and second sets of one or more electrodes are on opposite sides of the separation region; and/or
the first set of one or more electrodes is substantially parallel with the second set of one or more electrodes; and/or
the first set of one or more electrodes is substantially planar and/or wherein the second set of one or more electrodes is substantially planar; and/or
the first and/or second set of one or more electrodes comprises a plurality of electrodes; and/or
the first and/or second set of one or more electrodes comprises a plurality of electrode segments; and/or
the first and/or second set of one or more electrodes are on a printed circuit board, PCB; and/or
the first and second sets of one or more electrodes are substantially coplanar.

22. The apparatus of claim 20, wherein the first set of one or more electrodes comprises a counter electrode, wherein:
the counter electrode is a shaped counter-electrode, wherein the potential gradient has a shape corresponding to the shaped counter-electrode; and/or
a distance between the first set of one or more electrodes and the second set of one or more electrodes varies along a length of the separation region.

23. The apparatus claim 1, wherein:
the separation region is a vacuum region; and/or
the separation region is at a lower pressure than an upstream region of the apparatus and/or a downstream region of the apparatus.

24. The apparatus of claim 1, further comprising an accumulation region, configured to accumulate the ions, preferably wherein the electrode arrangement is configured to transfer the accumulated ions from the accumulation region to the separation region.

25. The apparatus of claim 24, wherein the accumulation region is upstream of the separation region and/or in parallel with the separation region.

26. The apparatus of claim 25, wherein the accumulation region is in parallel with the separation region and wherein the electrode arrangement is configured to switch between any one or more of:
a first configuration in which the electrode arrangement is configured to cause the ions to enter the accumulation region without passing through the separation region;
a second configuration in which the electrode arrangement is configured to cause the ions to enter the separation region without passing through the accumulation region; and
a third configuration in which the electrode arrangement is configured to cause the ions to enter the accumulation region and accumulate therein and to cause the accumulated ions to transfer from the accumulation region to the separation region.

27. The apparatus of claim 24, wherein the electrode arrangement is configured to:
transfer the ions from the accumulation region to the separation region; and
separate the ions in the separation region according to the mass-to-charge ratios of the ions;
wherein the apparatus is configured to refill the accumulation region while separating the ions in the separation region.

28. The apparatus of claim 1, wherein the separation region is a first separation region, the apparatus further comprising a second separation region in series with the first separation region, preferably wherein the first separation region is configured to perform a relatively coarse separation of the ions and the second separation region is configured to perform a relatively fine separation of the ions.

29. A mass spectrometry system comprising:
the apparatus for separating ions of claim 1; and
a mass filter downstream of the apparatus, the mass filter configured to receive the ions from the apparatus; the apparatus further comprising a mass analyser configured to receive the ions from the mass filter or to receive ions derived from the ions from the mass filter, and to perform mass analysis on the received ions.
